(19) United States
(12) Patent Application Publication
(10) Pub. No.: US 2012/0303544 A1
(43) Pub. Date: Nov. 29, 2012

(54) SITE SENTIMENT SYSTEM AND METHODS THEREOF

(76) Inventors: Ryan Sepiol, Scottsdale, AZ (US); Thom Brodeur, Scottsdale, AZ (US)

(21) Appl. No.: 13/456,645

(22) Filed: Apr. 26, 2012

Related U.S. Application Data
(60) Provisional application No. 61/489,956, filed on May 25, 2011.

(51) Int. Cl. G06Q 30/00; G06Q 50/22

(52) U.S. Cl. 705/347

(57) ABSTRACT

The present disclosure relates to content and, more particularly, to a site sentiment system and methods thereof. In one illustrative embodiment, the system can maintain health related content from a contributor such as a client or partner. The content can be an article, commentaries or other documented information. Associated with the content, a sentiment indicator can be used to receive esteems provided by a user viewing the content. The sentiment indicator can indicate esteems for “Improved My Health”, “Changed My Life” and “Saved My Life”. Using this information from a number of viewers of the content, a sentiment meter can be displayed showing the total esteems. Esteems can also be provided for the contributors. Links can be associated with the sentiment meter and provide associated health information. The meter can be visible on every page of the website or alternatively, be provided as an external widget for download.

### REFERENCE TO RELATED DISCLOSURES

This disclosure claims priority to U.S. Provisional Application Ser. No. 61/489,956 titled SITE SENTIMENT SYSTEM AND METHODS THEREOF to Ryan Sepiol and Thom Brodeur that was filed on May 25, 2011.

### TECHNICAL FIELD

This disclosure generally relates to content within a healthcare site, and more particularly, to a sentiment counter for providing esteems to the content.

### BACKGROUND

With increased growth of the Internet and the World Wide Web (WWW), it is common for online users to be bombarded with content from many contributors in the healthcare industry. Healthcare sites provide symptom checklist, pharmacy information, drug information, blogs of physicians with specific topics and places to store personal medical information. These sites are a leading health portal in the United States. A dedicated staff of professional journalists and board certified physicians who produce the site's content are employed by the site. The content can undergo a rigorous medical review process to ensure it is credible and accurate.

Nevertheless, users of these sites have experienced issues. In part, there is no traditional method of patient review of the content. Furthermore, content provided by a contributor is not linked resulting in the possibility that articles from the same contributor, who is an expert in the field, would not be displayed. A system and method is therefore needed whereby content can be reviewed with the reviews shared between viewers of the content. At the same time, content from contributors should be linked together to provide an easier method for accessing content. These, as well as other related advantages and features, will be described in the present disclosure.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present disclosure, a computer-implemented method for tracking sentiment among pages within a health, wellness or healthy living site is provided. The method can include providing content, displaying a sentiment indicator for the content, receiving esteems associated with the content through the sentiment indicator, tracking a total of the esteems and displaying the total of the esteems within a sentiment system.

In accordance with another aspect of the present disclosure, a server is provided. The server can include a database storing content provided by a plurality of users, at least one processor and a memory operatively coupled to the processor, the memory storing program instructions that when executed by the processor, causes the processor to perform a number of processes. The processes can include displaying a sentiment indicator associated with the content, receiving esteems selected within the sentiment indicator associated with the content and displaying a sentiment meter within sites on the server quantifying the esteems selected within the sentiment indicator.

In accordance with yet another aspect of the present disclosure, a system is provided. The system can include a server managing esteems for content provided by at least one contributor. The esteems can be tallied through a sentiment indicator and distributed on a sentiment meter associated with the server. The sentiment meter can be placed directly within a site of the server or on an external widget distributed anywhere on the World Wide Web (WWW).

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a block diagram representing exemplary software and hardware within a server in accordance with one or more aspects of the present disclosure;

FIG. 2 is an exemplary screen shot showing a sentiment indicator in accordance with one or more aspects of the present disclosure;

FIG. 3 is an exemplary confirmation dialog box in accordance with one or more aspects of the present disclosure;

FIG. 4 is an illustrative screen shot showing a collection of similar content in accordance with one or more aspects of the present disclosure;

FIG. 5 is an illustrative sentiment meter having a branded name in accordance with one or more aspects of the present disclosure;

FIG. 6 is an exemplary screen shot showing a profile page in accordance with one or more aspects of the present disclosure;

FIG. 7 is an exemplary screen shot showing the profile page and additional activities in accordance with one or more aspects of the present disclosure;

FIG. 8 is an illustrative sentiment widget tallying each of the esteems in accordance with one or more aspects of the present disclosure;

FIG. 9 is an illustrative external sentiment widget in accordance with one or more aspects of the present disclosure; and

FIG. 10 is an illustrative sentiment widget having a different interface in accordance with one or more aspects of the present disclosure.

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

Generally described, the present disclosure relates to content and, more particularly, to a site sentiment system and methods thereof. The content can be part of the WWW, broadcasted, applications and games, to name a few. In one illustrative embodiment, the system can maintain health related content from a contributor such as a client, partner, site user or consumer. The content can be an article, commentaries or other documented information. Associated with the content, a sentiment indicator can be used to receive esteems provided by a user viewing the content. The sentiment indicator can indicate esteems for “Improved My Health”, “Changed My Life” and “Saved My Life”. Using this information from a number of viewers of the content, a sentiment meter can be displayed showing the total esteems. Esteems can also be provided for the contributors. Links can be associated with the sentiment meter and provide associated health information. The meter can be visible on every page of the website or alternatively, be provided as an external widget for download.

Numerous advantages can be offered by the illustrative embodiment described above. Content as well as the contributors can be judged by site users and consumers. Ultimately, the more contributors and reviewers of the content, the greater the system will be. Furthermore, content can be linked to contributors. These contributors can be single time providers or be associated with a plurality of content. The site sentiment system can be tied to a single website or many sites that can be related or not. Many additional advantages of the present disclosure will become apparent to those skilled in the relevant art as provided for in the following description.

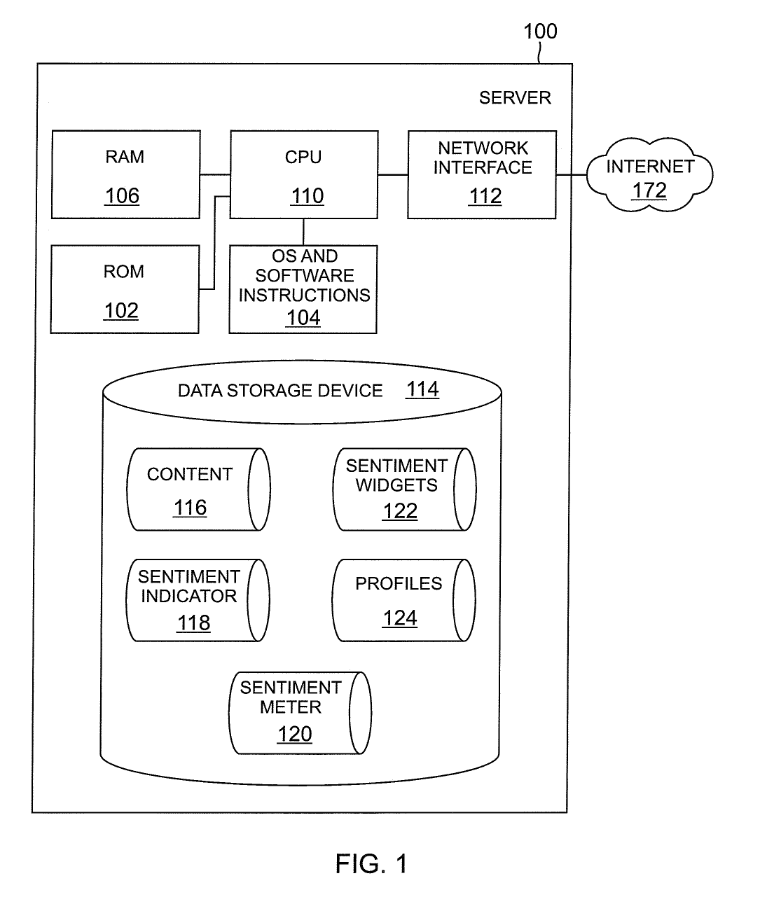

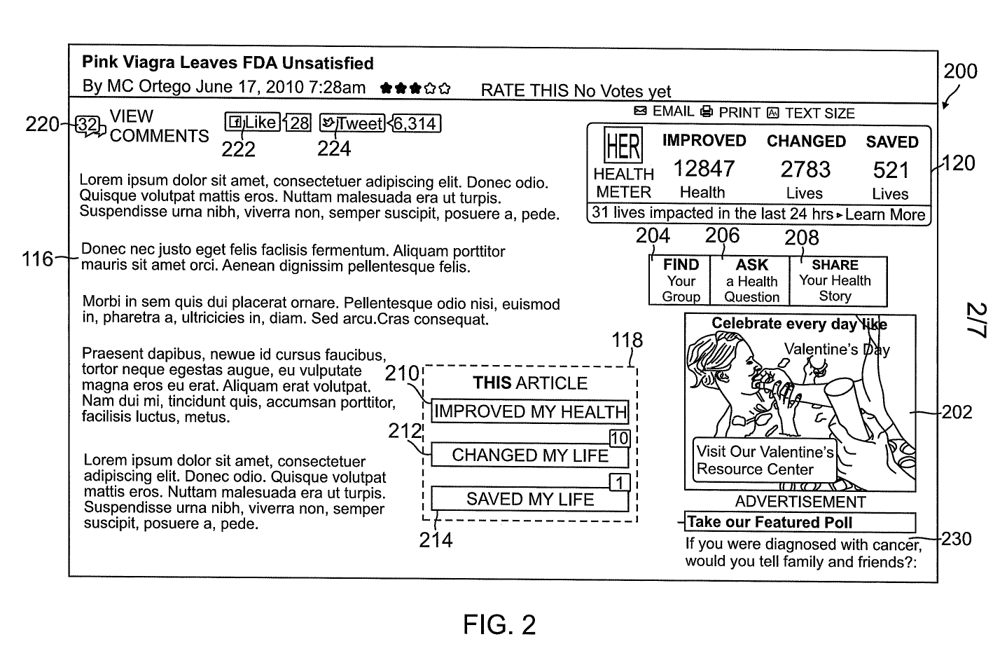

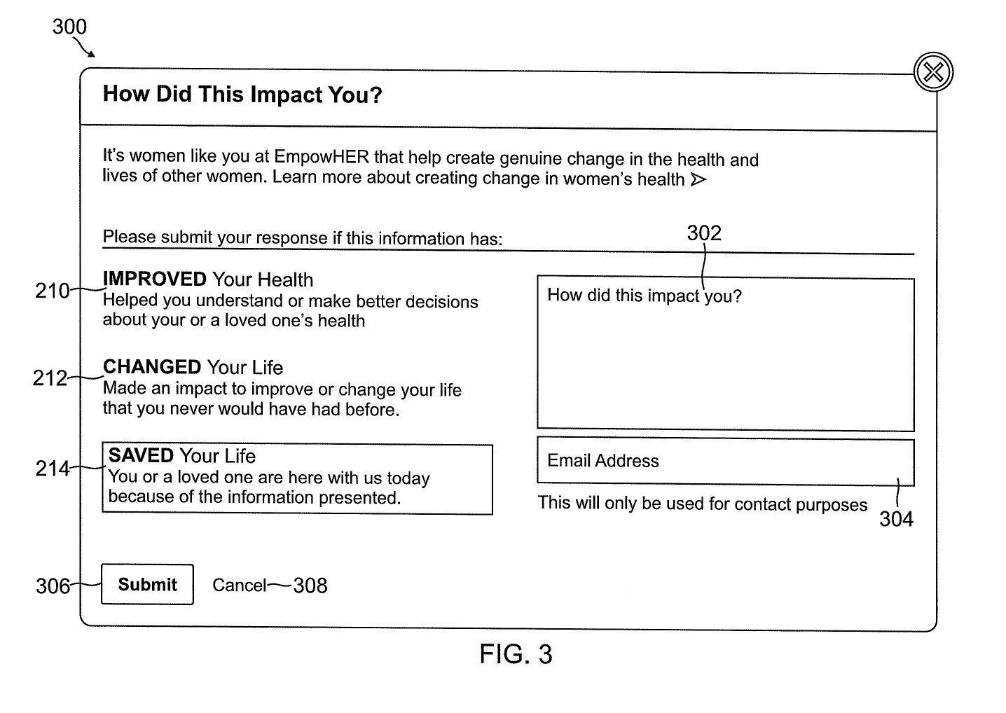

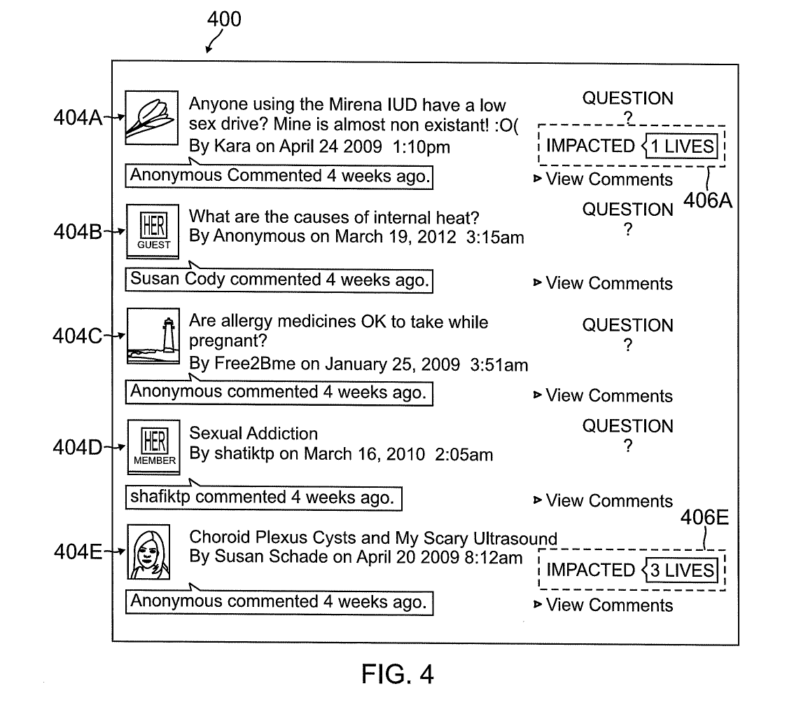

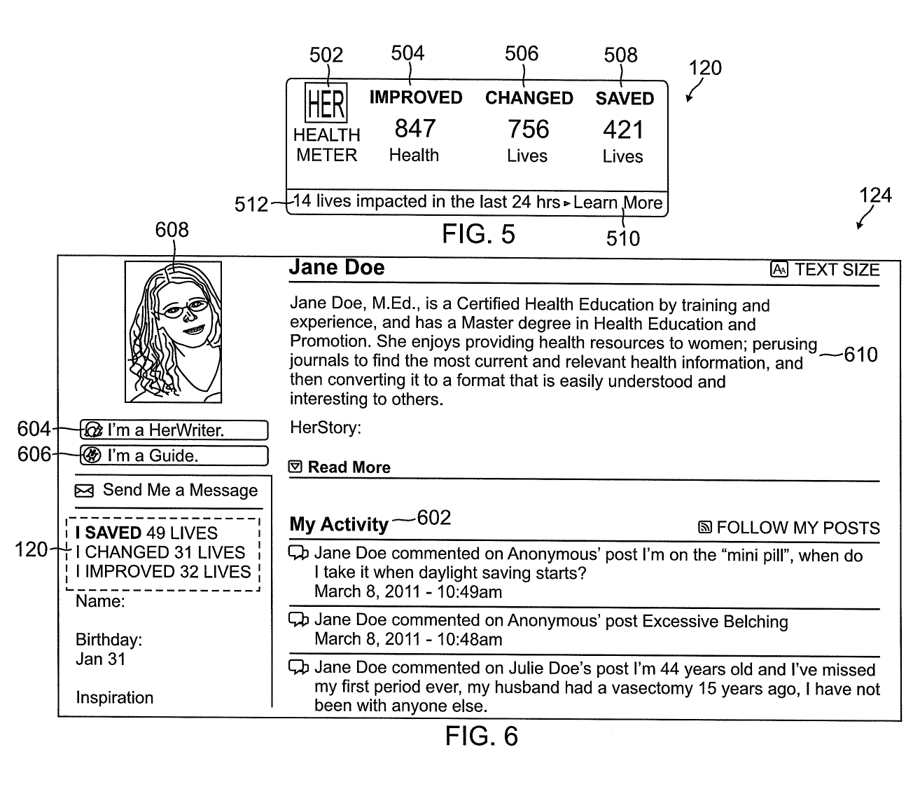

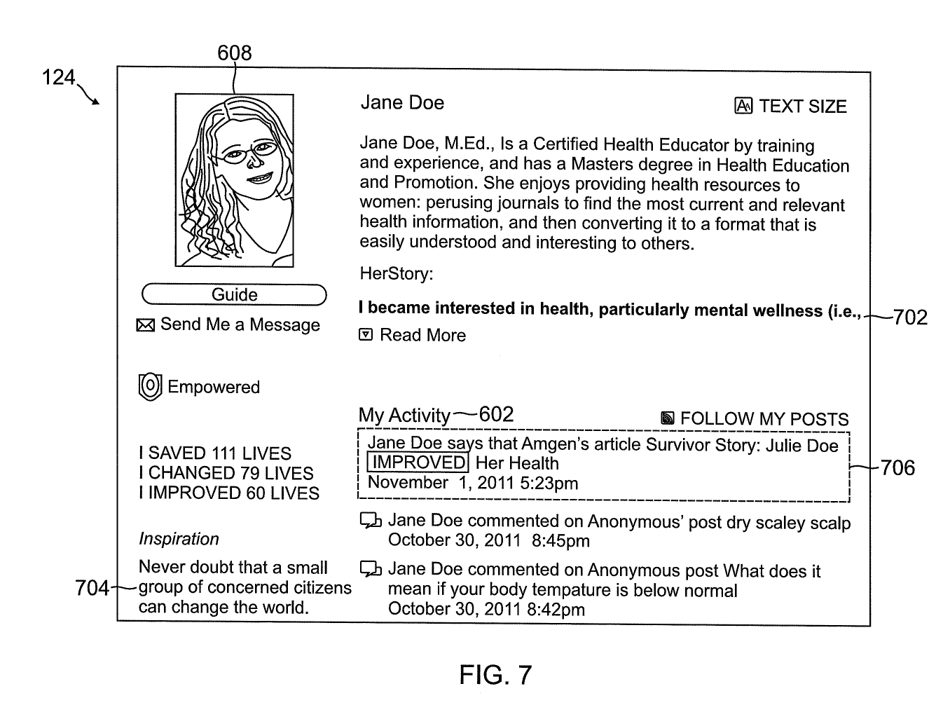

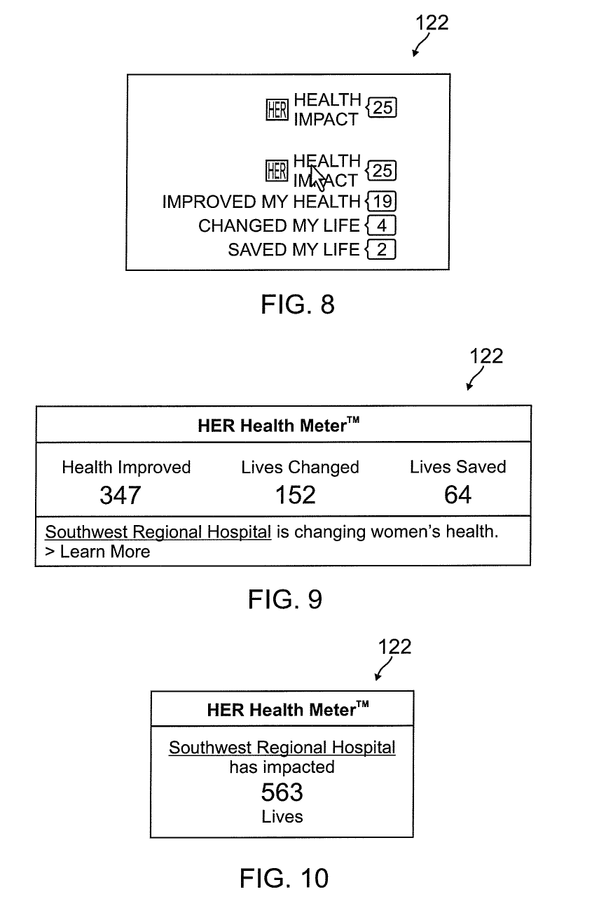

Before describing specific embodiments of the present disclosure, it should be noted that several references are made to EmpowHER.com, both in the written description and the FIGURES. While this site specifically relates to women's health issues, those skilled in the relevant art will appreciate that the present disclosure can generally refer to health, wellness and lifestyle issues and content, and still yet, other sites that can be linked or where content is shared. With that said, FIG. 1 depicts illustrative hardware and software for implementing site sentiment. An exemplary sentiment indicator is provided in FIG. 2 along with a confirmation dialog box in FIG. 3. FIG. 4 is a display of content summaries. A sentiment meter is described in FIG. 5. FIGS. 6 and 7 provide screen shots of a contributor's profile. FIGS. 8 through 10 describe an external sentiment widget.

Turning now to FIG. 1, a block diagram representing exemplary software and hardware within a server 100 in accordance with one aspect of the present disclosure is provided. The server 100 typically takes the form of a computer server, and can be a web server. The server 100 can provide access to EmpowHER.com, or other website, and in addition, the healthcare server 100 can keep track of information related to esteems. The server 100 can also be used to provide content to applications, games and other platforms that are not necessarily “web-related”. The server 100 can include a ROM 102, operating system and software instructions 104, a RAM 106, at least one central processor (CPU) 108, a network interface 112 connected to the Internet 172 and a data storage device 114. A conventional personal computer or computer workstation with sufficient memory and processing capability can be used as the server 100. Alternatively, multiple interconnected servers can also serve as the server 100.

The server 100 can handle high volumes of transactions and large amount of queries for communication and data processing. The RAM 106 and ROM 102 are used to support the program codes that are operated by the CPU 110. The memory can be in a form of a hard disk, CD ROM, or equivalent storage medium. The CPU 110 can support the authentications such as communications from external data servers, as well as allowing for anonymous transactions and general data encryption.

The data storage device 114 can include hard disk magnetic or optical storage units, as well as CD ROM, CD RW or DVD ROM and flash memory such as compact flash and secure digital cards. The data storage device 114 can contain content 116, instructions for executing a sentiment indicator 118, instructions for executing a sentiment meter 120, instructions for executing a sentiment widget 122 and profiles 124. Data can flow from each and be interconnected through logical or physical connections.

The healthcare server 100 can include a network interface 112 in order to communicate with other components over the Internet 172. For example, contributors can access their profiles 124 or content 116 through the interface 112. Users can also try to access the server 100 to view the content 116 and provide their remarks for the content 116 through the sentiment indicator 118 using the network interface 112 over the Internet 372. Conventional internal or external modems can serve as a network interface 112. A cable modem can be used as a network interface 112. The network interface 112 can support modems at a range of baud rate from 2400 and upwards.

While the above embodiment describes a single computer system acting as the server 100, the functionality can be distributed over multiple computing systems. The databases can also be distributed over a cloud computing environment. In one embodiment, the server 100 is configured in a distributed architecture, wherein the databases and processors are housed in separate units or locations. Some servers perform the primary processing functions and contain at a minimum RAM, ROM, and a general processor. Each of these servers is attached to a WAN hub which serves as the primary communication link with the other servers and interface devices. The WAN hub can have minimal processing capability itself, serving primarily as a communications router. Almost an unlimited number of controllers can be supported. This arrangement yields a more dynamic and flexible system, less prone to catastrophic hardware failures affecting the entire system.

FIG. 2 is an exemplary screen shot 200 showing a sentiment indicator 118 in accordance with one aspect of the present disclosure. For purposes of illustration, the content 116 within the screen shot 200 relates to an article titled “New Resources Support Patients Seeking An Empowered Death” by contributor Pat Elliot. Almost any type of content 116 can be displayed. Comments 220 can be provided for the article by viewers or other contributors. The content 116 can also be flagged with “Like” 222. While described for use with Facebook®, “Like” 222 can be part of other social networks such as MySpace®. “Like” 222 can refer to the content's approval by those who have viewed the content. The social network Twitter® can also be used with the article such that a viewer can “Tweet” 224 the article. “Tweet” 224 can refer to the content 116 being displayed on a social network such that when the content 116 is “Tweeted” the article is displayed on another forum. A number of different social networks or forums can be tied to the screen shot 200 and are not limited to those shown.

In one embodiment, the sentiment indicator 118 can be provided within the article. The text within the article can be wrapped around the sentiment indicator 118. Alternatively, the sentiment indicator 118 can be provided on a pop-up screen, independent tab or window. The sentiment indicator 118 can be placed on all content 116 within the site. In the illustration, the sentiment indicator 118 can provide esteems associated with the content 116 for “Improved My Health” 210, “Changed My Life” 212 or “Saved My Life” 214. Other esteems can be implemented within the sentiment indicator 118 or different terminologies can be used.

The sentiment indicator 118 can display multiple esteems that viewers physically select to indicate sentiment about a specific piece of content 116. Selection, in one embodiment, can refer to clicking on. When the viewer finds the content 116 useful, the user can select one of the esteems on the sentiment indicator 118. For example, the user can decide that the content 116 displayed “Improved My Health” 210, “Changed My Life” 212 or “Saved My Life” 214. Other types of esteems can be provided and implemented through the sentiment indicator 118. Generally, only one selection can be recorded for a viewer of any one piece of content 116. Cookies can be setup such that multiple selections of the same esteem can be prevented by the same viewer.

In the alternative, negative regards can be provided within the sentiment indicator 118. By way of a non-limiting example, the user can decide that the content 116 provided by the article was not very useful. The indicator 118 can provide a negative regard indicating that the article was “Not Useful.” A drop down menu or box can then be provided which can reference other content 116 that can be related. In one embodiment, a number of options or selections can be presented based on the article's content 116 to help facilitate the finding of information by the viewer. For example, the article shown in FIG. 2 can provide options of “Viagra”, “FDA”, “Español”, “Defects”, etc. The user can select the options that pertain to articles that they wish to see. When at least one option is selected, the sentiment indicator 118 can list related articles based on those options. The articles can be displayed based on a ranking of the esteems, for example, which article has the most “Changed My Life” 212 tallies. If only one article is present, the sentiment indicator 118 can immediately link to that article displaying a new screen.

Typically, a description can be provided with the esteems. When selected within the sentiment indicator 118, an explanation of the esteem can be provided. For example, when “Improved My Life” is selected, the sentiment indicator 118 provides a detailed description. This can be performed by a right click or through some other method, such as scrolling over the esteem. It is envisioned, that all relevant content 116 is to be made esteem-able. Esteems can be associated with group threads, articles, health tips, provider articles (ability to turn on/off esteems), provider videos (ability to turn on/off esteems), asks, shares, news, HERArticles, slideshows and videos. HERArticles can refer to content 116 within EmpowHER.com.

Along with the sentiment indicator 118, other options can be provided to the viewer. For example, “Find Your Group” 204, “Ask a Health Question” 206 or “Share Your Health Story” 208 can be provided within or next to the content 116. Advertisements 202 can also be displayed. In one embodiment, the advertisements 202 can also be esteemed. Featured polls 230 can be provided and esteemed. These polls 230 can be used to take other relevant information that can be related to the article, or not. By way of a non-limiting example, and as shown, the poll can ask “If you were diagnosed with cancer, would you tell family and friends?” This information can be collected and processed by the server 100 to provide valuable statistics on studies. When the poll 230 is completed, the results for the current poll can be shown on the screen shot 200 of FIG. 2. A sentiment meter 120 can also be shown. Essentially ‘any’ content type or contributor can be esteemed and measured by the sentiment system. More details regarding the sentiment meter 120 will be described below.

After “Improved My Health” 210, “Changed My Life” 212 or “Saved My Life” 214 has been selected, the server 100 can provide a confirmation dialog box 300 as depicted in FIG. 3. The more times that an esteem 210, 212 or 214 is selected, the more valuable the piece of content 116 can become. Upon clicking a sentiment indicator 118, the box 300 appears. The box 300 can take many forms and shapes. In one embodiment, the box 300 can be provided in a pop up as shown in many advertisements. Alternatively, the box can replace the current screen shot 200.

The confirmation dialog box 300 can provide a description of each indicator esteem choice. For example, below “Improved My Health” 210, a short statement of “Helped you understand or make better decisions about your or a loved one's health.” can be shown. Along with “Changed My Life” 212, a statement of “Made an impact to improve or change your life that you never would have had before.” can be displayed. Finally, “Saved My Life” 214 can be associated with “You or a loved one are here with us today because of the information presented.” Other similar messages can be provided with each of the sentiment indicators 118.

A highlighted box or the like can surround the selected sentiment indicator 118. In this case, the “Saved My Life” 214 along with the associated message can be surrounded by the highlighted box. The confirmation dialog box 300, in one embodiment, can provide a link to a page with detailed information about the EmpowHER Esteem System operating on the server 100. The box 300 can also allow the user to change their indicator 118 by simply clicking or selecting another choice.

In addition, the confirmation dialog box 300 can provide a dialog box 302. Displayed in or around the box 302 can be a message “How did this impact you?”. In this box 302, the user who selected the sentiment indicator 118 can provide more specific information about how the content 116 on the server 100 impacted them. By way of a non-limiting example, the user can select “Saved My Life” 214 and provide specific details of how to take the medicine proposed by the content 116. An electronic mail (email) field 304 can also be displayed within the confirmation dialog box 300. The email address can be used so that the author, administrator or some other party can contact the user. The email address typically will remain anonymous to outside users.

In the shown embodiment, a confirmation button 306 can be provided. The button 306 can be used to submit the information including the final sentiment indicator 118 selected and any additional information provided either in the box 302 or the email address field 304. A cancel button 308 can also be provided. Information entered into the confirmation dialogue box 300 can be removed either before the submit button 306 is pressed or afterwards. When the confirmation button 306 or cancel button 308 is selected, the box 300 is closed and the content page is returned to.

FIG. 4 is an illustrative screen shot 400 showing a collection of similar content 116 in accordance with one or more aspects of the present disclosure. The server 100 can provide summaries of the content 116 being uploaded into the system. The content 116 can be displayed in a vertical fashion whereby entry 404A is above entry 404B and entry 404B is above entry 404C and so forth. The entries 404A, 404B, 404C, 404D and 404E (collectively entries 404) can be arranged based on when the content 116 was added into the system. Alternatively, the entries 404 can be arranged when they were last esteemed.

Typically, the entries 404 can each have a photo or other indicia associated with the poster of the content 116. The indicia can show the user's face or other symbol that is of relevance to the poster. In embodiments of the present disclosure, indicia representing the poster as a guest can be provided, for example, “HER GUEST”. The entries 404 can show the number of lives they impacted. By way of a non-limiting example, entry 404A shows the number of impacted lives 406A to be one, while entry 404E shows three impacted lives 406E. Hyperlinks can be provided to the content 116, if selected. A uniform resource locator (URL) can be provided if it links to an external site.

The screen shot 400 can also provide content 116 that is similar, or related, to each other. For example, the entries 404 can be related to “sex/pregnancy” related topics. The server 100 can automatically group in content 116, not only from its internal database, but from outside sources as well. Question marks can be provided by entries 404. When selected, questions can be provided by a user that are related to the content 116 of the entry 404, as shown as entries 404B, 404C and 404D.

The server 100 can also provide an analysis of data for epidemiological reasons. Patterns of health-events, health-characteristics and their causes or influences in well-defined populations can be maintained. This data can be used for content discovery for advertisers, researchers and users.

The server 100 can track the selections within the sentiment indicator 118 to keep vital statistics for the content 116. FIG. 5 is an illustrative sentiment meter 120 having a branded name 502 in accordance with one aspect of the present disclosure. The sentiment meter 120 provides a graphical display of esteem totals that were received by the sentiment indicator 118 in the content 116. The sentiment meter 120 can be used to display the previously collected data from the sentiment indicator 118. The sentiment meter 120 can be placed on all pages of a site within EmpowHER.com or other network. The sentiment meter 120 can also appear near site writers, guides, moderators and experts who are responsible for the content and community interaction. This is a quantification of the esteems that are input by the viewers noted above. In one embodiment, audible queues can be provided that reflect updated changes within the sentiment meter 120.

The esteem information entered into the sentiment indicator 118 can be tallied and displayed. The sentiment meter 120 can provide an active counter whereby information is tallied in real time. For example, when a viewer selects “Improved My Health” 210 on the sentiment indicator 118, an associated “Health Improved” 504 can be incremented regardless of whether it is another viewer or the viewer who selected “Improved My Health” 210. “Changed My Life” 212 on the sentiment indicator 118 can be associated with “Lives Changed” 506 whereby each time a user selected “Changed My Life” 212, the “Lives Changed” 506 increments. “Saved My Life” 214 on the sentiment indicator 118 is associated with “Lives Saved” 508. Each time “Saved My Life” 214 is selected, the counter for “Lives Saved” 508 can be incremented.

On a bottom portion 512 of the sentiment meter 120, a counter can be kept that shows tracked data corresponding to a period of time. For example, the number of lives saved within a twenty-four period can be determined and displayed within the bottom portion 512. Those skilled in the relevant art will appreciate that the period of time can change. In one embodiment, when the bottom portion 512 is selected, or clicked-on, the displayed information can be toggled. For example, the number of lives impacted within twelve hours can be displayed. The sentiment meter 120 can also provide additional information in the form of “Learn More”.

An internal administrative page can be used to monitor not only the sentiment indicator 118, but the sentiment meter 120 as well. Through this page, as well, the number of viewers can be displayed. Audience sizes can be shown based on demographics. The growth or shrinkage of the number of viewers can also be displayed and can be monitored over a period of time. Data that is collected can be sorted and then exported through the internal administrative page, or externally via packaged reports. Audience sizes can be shown.

Referring now to FIG. 6, an exemplary screen shot showing a profile 124 page in accordance with one aspect of the present disclosure is provided. The profile 124 can include information related to the contributor of the content 116. The contributor's biography 610 can be displayed. The profile 124 can also include their recent activity 602. By providing the recent activity 602, the user can follow the contributor's posts. A picture 608 of the contributor can be provided as well as their birthday, name and occupation.

On the profile 124, the contributor can specify what type of provider they are, for example, Jane Doe has specified that she is a “HerWriter” 604 and a “Guide” 606. By being a “HerWriter” 604, Jane Doe can specify that she writes articles for the site. The contributor, through their profile 124, can also be esteemed. These esteems are being presented by members of the community that can include viewers or other contributors. When the contributor's content 116 is esteemed, the contributor is also esteemed. “Guide” 606 can refer to a contributor who acts as a site guide or moderator. The contributor can comment, review, share or post information about other contributors. By acting as a “Guide” 606, the contributor can also be esteemed.

Within the contributor's profile 124 can be esteem counts. The esteem counts can be provided within a graphical display and show the total impact the contributor's content 116 has had on visitors of the site. The total number of esteems given via the sentiment indicator 118 to a contributor's content is displayed by esteem type. This can be displayed on the contributor's profile 124 on a sentiment meter 120.

Each of the profiles 124 can be associated with members of the server 100. In turn, the members can be esteemed by the content 116 that they generate, review, share, etc. In turn, the members can be ranked or sorted by highest to lowest esteems. Furthermore, the members can be refined to categories that they belong to, for example, the member can define themselves as an expert in heart issues. In one embodiment, the profiles 124 can be associated with those presented in a social network or the like. They can be ranked by “Improved Health” 504, “Changed Lives” 506 and “Saved Lives” 508. The members can be separated by latest person to be esteemed in all categories or by “Improved Health” 504, “Changed Lives” 506 and “Saved Lives” 508. In one embodiment, the members can be separated into the most impactful member, for example, the member that has the most esteemed points. The members can also be sorted or filtered by condition. The data collected can be exposed on a description page. It can be placed where users and others interested in the data can see it.

FIG. 7 is an exemplary screen shot showing the profile page 124 and additional activities 602 in accordance with one or more aspects of the present disclosure. Within the profile page 124, a total impact of each item of user generated, client/partner or external content 116 has had on users can be shown. Hyperlinks can be created to point to a content piece. If the content 116 is on an external site or display, URLs can be provided that point to the external site. In addition, files can be uploaded from a remote site. Dates and the times of when esteems were provided can also be shown on the profile 124. In addition, historical display of profile owner's esteem activities on both the EmpowHer.com site and external content can be kept tracked of. As shown, the activity 602 of Jane Doe can indicate that she has commented or provided esteems on other content 706. A description page can also be provided within the profile 124 explaining the site sentiment system and what is exactly being measured and detailing which esteems mean.

The sentiment indicator 118 and sentiment meter 120, in some embodiments, can be sponsorable. Ad space can be provided within each and represent a source of income. As shown above, almost any type of content can be esteemed. To name a few, group threads, articles, health tips, provider articles (ability to turn on/off esteems), provider videos (ability to turn on/off esteems), asks, shares, news, HERArticles, slideshows and videos can be esteemed. The esteems can be sortable and filtered by a number of conditions including highest to lowest, relevance, demographics, etc. Through the administrator page, described above, users, or members of the site, can see and manipulate the esteem and ratings.

FIG. 8 is an illustrative sentiment widget 122 tallying each of the esteems in accordance with one or more aspects of the present disclosure. As shown, the number of esteems can total twenty-five but reflect different areas. Individual counts for each esteem type can also be kept tracked of. In one embodiment, the individual esteem inputs and esteem counts can be displayed individually when a user's mouse pointer is positioned over the total number of esteems.

FIG. 9 is an illustrative external sentiment widget 122 in accordance with one aspect of the present disclosure. Sentiment widgets 122 can be distributable tools with RSS, MRSS or API connectivity to and from other sites, for example, web sites, portals, publishers, client micro-sites, etc. Typically, sentiment widgets 122 can come in two forms: one to extend the sentiment indicator 118 functionality to sites outside of its network and a second to extend the sentiment meter 120 functionality to sites inside of its network. Data can be collected, aggregated and displayed on EmpowHER.com, or any sites within its network, or on any other external sites as designated by EmpowHER.com.

Through the external sentiment widget 122, data can be received through a sentiment indicator 118. The data can then be tracked and monitored. The data can be provided as output through a sentiment meter 120. The sentiment widget 122 allows users, clients and partners to export code to display a user specific sentiment indicator widget on web sites and social media profiles outside EmpowHER.com and the network. The sentiment widget 122 can allow viewers to select one of three esteems, for example, to share sentiment about content 116 being viewed. Generally, only one selection can be recorded for a user on any one piece of content 116. The EmpowHER.com brand identification can be provided with a link to EmpowHER.com.

The external sentiment widget 122 can also allow users, clients and partners to export code on web sites and social media profiles outside EmpowHER.com and the network that displays data collected from the healthcare server 100. The widget 122 can display the contributor's esteems. In one embodiment, the viewers provided esteems can be shown. Typically, the widget 122 displays the aggregated number of esteems of the contributor on EmpowHER.com, or EmpowHER.com-affiliated and authorized web sites.

Generally, there are two versions of the external sentiment widget 122. In one embodiment, the external sentiment widget 122 can be provided as a full display as shown in FIG. 9. The total number of esteems given to a site's content is displayed by esteem type. The widget 122 can include an EmpowHER.com brand identification area and numerical display of total esteems by type. The widget 122 can also include a link to the contributor's profile 124 on EmpowHER.com.

FIG. 10 is an illustrative sentiment widget 122 having a different interface in accordance with one aspect of the present disclosure. This mini display, in one embodiment, can show the total “impact” on lives the contributor has made. “Improved Health” 404, “Changed Lives” 406 and “Saved Lives” 408 are displayed as one number. In addition, the widget 122 can include an EmpowHER.com brand identification area. Links to a detail page describing the widget 122 and associated esteems on EmpowHER.com can be provided. Links to the contributor's profile 124 on EmpowHER.com can also be provided.

The external sentiment widget 122 allows other sites and social media profiles the ability to measure the impact their content has on their viewers' health as an independent sentiment measurement system outside the EmpowHER.com site. Code is generated and installed on external sites that enable two types of functionality. The widget 122 integrates esteems with content 116 and allows users to select one of three esteems to share sentiment about the content 116.

In one embodiment, a custom sentiment measurement service can be provided that would allow sentiment systems to be defined by a user and implement via code installed. This can give other sites and social media profiles the ability to measure the impact their content has based on user defined esteems. Esteems are input by user when setting up sentiment measurement service. This can allow sites to measure their users' sentiment around any topic. For example, content 116 can be found to be “Helpful” or “Not Helpful” or the content 116 can be described as “Uncool”, “Cool” or “Really Cool”. The content 116 can also be esteemed by whether it “Saved Me Money”, “Saved Me Time” or “Saved Me Effort”. There are a number of different sentiments that can be provided.

Sentiment indicators 118 can also be provided on social network sites, apps or games. Social networks can provide a number of features and functions for those participants that have become part of the network. For each user, a personal space can be defined. A personal space can be used to setup information specific and general to a user. By way of non-illustrating examples, the personal space can allow a user to disclose their name or alias. Personal information can be provided that includes their cell number, home number, address, place of employment, date of birth, etc. Sentiment indicators 118 and meters 120 (external meters 122 as well) can be extended to offline people and locations through check-in programs like FourSquare® and Facebook®.

In one embodiment, content published by the user on their social network profile can have a sentiment indicator 118. Each time an esteem is selected, the widget 122 associated with the user's profile can be updated. Through the social network, content can be distributed and can be reviewed through the sentiment indicator 118. Information associated with the main website, EmpowHer.com, can be linked to the content on the social network whereby esteems made through the sentiment indicator 118 on the social network can affect the sentiment widget 122 on the EmpowHer.com site. Content can be shared with a number of people connected into the social networking site. Private content can also be distributed among “friends” or “connections”. A number of different graphical interfaces can be provided for the sentiment indicator 118 and the sentiment widget 122.

The sentiment indicator 118 and sentiment widget 122 can be provided to other sites having content for free, in one business model. The indicator 118 and widget 122 can be provided to health and wellness related sites or in the alternative, other sites where users can review the content. Members of a social network or online community of interest can provide esteems on each and the widget 122 can be updated.

A third option to the sentiment indicator 118 and sentiment widget 122 can be provided. This third device can be a meter that can be used to provide a stamp of verification or approval. The verification meter can keep a running total of the esteems for content or contributors, and when the total reaches a certain threshold, the content, contributor or site can be designated as a trusted source. For purposes of illustration, a user's content has 1,000,000 “Improved My Health” 210 selections, which is above the threshold. The user's content, or the user themselves, can then be designated as a verifiable source.

In one embodiment, different participants who provide esteems can be counted more heavily than others. For example, doctors in the user's field can be given more weight than those who are just searching the EmpowHer.com site. In essence, fewer doctors would be needed to give their stamp of approval than regular searchers on the site. An indicator can be provided when a user, or their content, has been verified or stamped with approval. This can be displayed to those who view the user's content to show that the user has knowledge and is a reputable source within the field. In one embodiment, these reputable contributors, such as doctors, would provide their own esteemed labels.

As previously described, the sentiment system can be used with, or as part of, a social network. Other sites and social media profiles can have the ability to measure a user's impact on content and the impact it has on other users' health as an independent sentiment measurement system outside the EmpowHER site sentiment system. Code can be generated and installed on these external sites that allow two types of functionalities: integrates esteems with content and allows users to select one of three options or “Esteems” to share sentiment about content being viewed. The esteem counts can be displayed on a user's page of choice. Measurement services can provide statistics about user input on their content.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present disclosure, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A computer-implemented method for tracking sentiment among pages within a healthcare site, the method comprising:
providing content;
displaying a sentiment indicator for the content;
receiving esteems associated with the content through the sentiment indicator;
tracking a total of the esteems; and
displaying the total of the esteems within a sentiment meter.

2. The computer-implemented method of claim 1, comprising receiving the content from at least one of a client, partner, site user and consumer.

3. The computer-implemented method of claim 1, wherein providing the content comprises displaying at least one of an article, commentary and document.

4. The computer-implemented method of claim 1, wherein displaying the sentiment indicator for the content comprises showing esteems for “Improved My Health”, “Changed My Life” and “Saved My Life”.

5. The computer-implemented method of claim 4, wherein displaying the total of the esteems within a sentiment meter comprising showing the total of the esteems for “Improved My Health”, “Changed My Life” and “Saved My Life”.

6. The computer-implemented method of claim 1, comprising providing links with the sentiment meter for the esteems showing associated health information.

7. The computer-implemented method of claim 1, wherein displaying the total of the esteems within the sentiment meter comprises presenting the sentiment meter on each page within the healthcare site associated with a provider of the content.

8. The computer-implemented method of claim 1, wherein displaying the total of the esteems within a sentiment meter comprises presenting the sentiment meter on a widget downloadable from the healthcare network.

9. The computer-implemented method of claim 1, comprising receiving a comment regarding the content and storing the comment with the content.

10. The computer implemented method of claim 1, comprising displaying an explanation of the esteems when selected.

11. The computer-implemented method of claim 1, comprising displaying a poll to find statistical information for a study.

12. A server comprising:
a database storing content provided by a plurality of users;
at least one processor; and
a memory operatively coupled to the processor, the memory storing program instructions that when executed by the processor, causes the processor to:
display a sentiment indicator associated with the content;
receive esteems selected within the sentiment indicator associated with the content;
display a sentiment meter within sites on the healthcare server quantifying the esteems selected within the sentiment indicator.

13. The server of claim 12, wherein the memory storing the program instructions, when executed, causes the processor to receive details on how the content helped a user and store the details with the content.

14. The server of claim 12, wherein the memory storing the program instructions, when executed, causes the processor to display the sentiment meter on at least one of a writer's page, guide, moderator's page and expert's page who is responsible for the content.

15. The server of claim 12, wherein the memory storing the program instructions, when executed, causes the processor to track the esteems selected over a period of time.

16. A system comprising:
a server managing esteems for content provided by at least one contributor, wherein the esteems are tallied through a sentiment indicator and distributed on a sentiment meter associated with the server, the sentiment meter placed directly within a site of the server or on an external widget.

17. The system of claim 16, wherein the esteems are tallied in real time and updated on the site or the external widget.

18. The system of claim 16, wherein the server provides biographical information of the at least one contributor.

19. The system of claim 16, wherein the server ranks the at least one contributor based on at least one of tallied esteems by category and most impactful.

20. The system of claim 16, wherein the tallied esteems are linked with a profile residing on a social network of the at least one contributor.
